(19) United States
(12) Patent Application Publication
(10) Pub. No.: US 2026/0154540 A1
(43) Pub. Date: Jun. 4, 2026

(54) QUANTIZATION-AWARE LORA FINE-TUNING FOR LLM

(71) Applicant: MediaTek Singapore Pte. Ltd., Singapore (SG)

(72) Inventors: Jia Yao Christopher Lim, Singapore (SG); Ya-Lin Huang, Hsinchu City (TW); Huai-Ting Li, Hsinchu City (TW); Wai Mun Wong, Singapore (SG); Jen-Wei Liang, Hsinchu City (TW); Timothy Jun Jie Lee, Singapore (SG)

(21) Appl. No.: 19/405,525

(22) Filed: Dec. 2, 2025

Related U.S. Application Data
(60) Provisional application No. 63/726,683, filed on Dec. 2, 2024.

(51) Int. Cl. G06N 3/0495; G06F 17/16; G06N 3/048; G06N 5/04

(52) U.S. Cl. CPC G06N 3/0495; G06F 17/16; G06N 3/048; G06N 5/04

(57) ABSTRACT

In an aspect of the disclosure, a method of using a LoRA for inference with a FC layer of a LLM is provided. The method includes: dequantizing an INT input to an FP output; processing the FP output from the DQ and a first FP input from first weights of a down projection module of the LoRA, to output a first FP output; processing the first FP output from the first BMM and a second FP input from second weights of an up projection module of the LoRA, to output a second FP output; quantizing the second FP output to an INT output; multiplying the INT output, to output a multiplied INT output; adding an INT FC output, from the FC layer, and the multiplied INT output, to output an INT LoRA output; and quantizing the INT LoRA output to an INT inference output.

This application claims the benefit of U.S. provisional application Ser. No. 63/726,683, filed Dec. 2, 2024, the disclosure of which is incorporated by reference herein in its entirety.

### TECHNICAL FIELD

The disclosure relates in general to low rank adapter (LoRA) for inference with a fully connected (FC) layer of a large langue model (LLM), and more particularly, to techniques of computing device and method for using LoRA to fine-tune multiple adapter weights for different LLM tasks.

### BACKGROUND

Due to large parameter size of Large Language Models (LLMs), training LLMs takes an extremely large amount of computation, memory, costs and time, such as taking weeks of training on multiple high-cost processors, such as graphics processing units (GPUs). Nowadays, low-rank adapters (LoRAs) is used for accelerating the training process of LLMs for multiple tasks, which including sets of additional parameters added onto an LLM's original parameters in the form of an adapter, and applied to modify the original LLM parameters. For training LoRAs, the original model weights (parameters of LLMs) are frozen and only the added parameters are trained, which cuts down on training computation, time and resources. However, different tasks of LLMs require different sets of weights, which means that the modified original parameters (original model weights) cannot be shared, and the modified original parameters cannot be shared with different tasks of LLMs. For example, a 7 billion parameter model quantized at 4 bits for weights would take up 3.5 GB of memory, such that multiple copies of such 3.5 GB quantized model (LLM) is difficult to be deployed onto an edge device. Thus, there are needs for techniques of all LoRA tasks being trained to accommodate the same base model weights, and enabling quick swapping between trained LoRA adapter weights.

### SUMMARY

The first aspect of the present disclosure features a low rank adapter (LoRA) for inference with a fully connected (FC) layer of a large language model (LLM). The LoRA includes a dequantizer (DQ) coupled to the FC layer and configured to dequantize an integer (INT) input to a floating point (FP) output. The LoRA also includes a first batched matrix multiplication (BMM), coupled to the DQ and configured to process the FP output from the DQ and a first FP input from first weights of a down projection module of the LoRA, to output a first FP output. The LoRA also includes a second BMM coupled to the first BMM and configured to process the first FP output from the first BMM and a second FP input from second weights of an up projection module of the LoRA, to output a second FP output. The LoRA also includes a quantizer, coupled to the second BMM and configured to quantize the second FP output to an INT output. The LoRA also includes a multiplier coupled to the quantizer and configured to multiple the INT output, to output a multiplied INT output. The LoRA also includes an adder coupled to the FC layer and the multiplier, and configured to add an INT FC output, from the FC layer, and the multiplied INT output, to output an INT LoRA output. The LoRA also includes a requantizer, coupled to the adder and configured to quantize the INT LoRA output to an INT inference output.

The second aspect of the present disclosure features a computing device. The computing device includes a processor, configured to execute an inference of a LLM. The computing device also includes a deep learning accelerator (DLA) coupled to the processor and compiled with A LoRA for the inference with a FC layer of the LLM. The computing device also includes a memory coupled to the processor and the DLA, and configured to store first weights of a down projection module of the LoRA and second weights of an up projection module of the LoRA. The LoRA includes a DQ coupled to the FC layer and configured to dequantize an INT input to a FP output. The LoRA also includes a first BMM, coupled to the DQ and configured to process the FP output from the DQ and a first FP input from first weights of a down projection module of the LoRA, to output a first FP output. The LoRA also includes a second BMM coupled to the first BMM and configured to process the first FP output from the first BMM and a second FP input from second weights of an up projection module of the LoRA, to output a second FP output. The LoRA also includes a quantizer, coupled to the second BMM and configured to quantize the second FP output to an INT output. The LoRA also includes a multiplier coupled to the quantizer and configured to multiple the INT output, to output a multiplied INT output. The LoRA also includes an adder coupled to the FC layer and the multiplier, and configured to add an INT FC output, from the FC layer, and the multiplied INT output, to output an INT LoRA output. The LoRA also includes a requantizer, coupled to the adder and configured to quantize the INT LoRA output to an INT inference output.

The third aspect of the present disclosure features a method of using a LoRA for inference with a FC layer of a LLM. The method includes dequantizing, by a DQ coupled to the FC layer, an INT input to an FP output. The method also includes processing, by a first BMM coupled to the DQ, the FP output from the DQ and a first FP input from first weights of a down projection module of the LoRA, to output a first FP output. The method also includes processing, by a second BMM coupled to the first BMM, the first FP output from the first BMM and a second FP input from second weights of an up projection module of the LoRA, to output a second FP output. The method also includes quantizing, by a quantizer coupled to the second BMM, the second FP output to an INT output. The method also includes multiplying, by a multiplier coupled to the quantizer, which has the INT output, to output a multiplied INT output. The method also includes adding, by an adder coupled to the FC layer and the multiplier, an INT FC output, from the FC layer, and the multiplied INT output, to output an INT LoRA output. The method also includes quantizing, by a requantizer coupled to the adder, the INT LoRA output to an INT inference output.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is a diagram illustrating an example computing device, according to some implementations of the present disclosure.

FIG. 2A is a diagram illustrating an example of joint PTQ for training multiple LoRAs and original weights of the FC layer for different tasks.

FIG. 2B is a diagram illustrating an example of individual PTQ/QAT for training multiple LoRAs and original weights of the FC layer for different tasks.

FIG. 3 is a diagram illustrating the example of Quantization-Aware LoRA Fine-Tune (QALFT) for training LoRAs and original weights of the FC layer for different tasks, according to some implementations of the present disclosure.

FIG. 4 is a diagram illustrating an example of the training structure of QALFT for LoRA and original weights of the FC layer for different tasks, and the inference structure of LoRA and the FC layer for different tasks according to some implementations of the present disclosure.

FIG. 5 is a flowchart of an example process for inference by LoRA with a FC layer of a LLM, according to some implementations of the present disclosure.

In the following detailed description, for purposes of explanation, numerous specific details are set forth in order to provide a thorough understanding of the disclosed implementations. It will be apparent, however, that one or more implementations may be practiced without these specific details. In other instances, well-known structures and devices are schematically shown in order to simplify the drawing.

### DETAILED DESCRIPTION

The following disclosure provides many different implementations, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include implementations in which the first and second features are formed in direct contact, and may also include implementations in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various implementations and/or configurations discussed.

The terms “comprise,” “comprising,” “include,” “including,” “has,” “having,” etc. used in this specification are open-ended and mean “comprises but not limited.” The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various implementations given in this specification.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative implementations but, like the illustrative implementations, should not be used to limit the present disclosure. The elements included in the illustrations herein may not be drawn to scale.

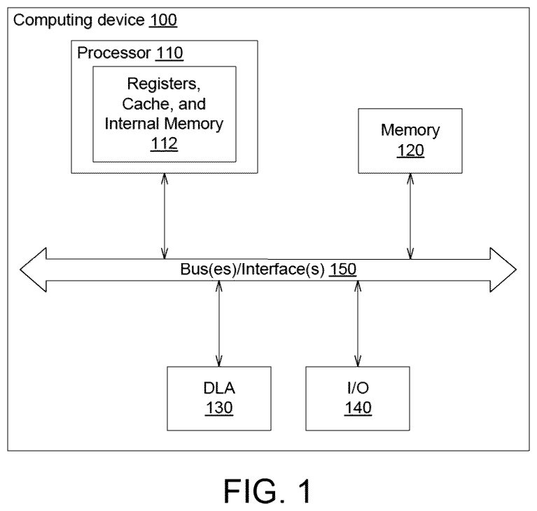

FIG. 1 is a diagram illustrating an example computing device 100, according to some implementations of the present disclosure. The computing device 100 includes a processor 110, a memory 120, a DLA (deep learning accelerator) 130 and I/O 140 that are coupled by Bus(es)/Interface(s) 150. The computing device 100 can execute functions of AI (artificial intelligent) models, such as inference of LLMs (large language models).

The processor 110 includes one or more processing units, such as any combination of hardware units enabled to execute programmed instructions, microprocessors, signal processors, AI processors, and the like as CPU, or such as any combination of units enabled to accelerate processing for processing that is subject to relatively highly parallel processing, such as graphics processing, signal processing, and/or AI processing, as GPU. One or more of the processing units optionally comprise one or more internal registers (some of which are optionally architecturally visible), one or more cache memories, and/or one or more internal memories (such as relating to buffering and/or coalescing), as represented by Registers, Cache, and Internal Memory 112. In some implementations, the processor 110 can be used for executing functions or components of LLMs, such as FC layer(s) of LLMs.

The memory 120 includes one or more memory devices or memory arrays for storage of instructions and/or data in greater quantities than storage internal of processor 110. The memory 120 can be also implemented as one or more storage elements, such as flash-based storage element, or other storage devices, for storage of instructions and/or data. In some implementations, the memory 120 can be used for storing weights of LLMs, such as trained weights of FC layer or trained weights of LoRA connected to FC layer.

The DLA 130 can include specified circuit for specified algorithms or AI models, such as deep learning algorithms or models, or LLMs, which provides circuit combinations or processing unit with dedicated or general accelerating functions. For example, DLA 130 can include, but not limited to, dedicated digital circuits, such as adders, multipliers, comparators and matrix multiplication units, to accelerate deep learning algorithms or models, including LLMs. For example, batched matrix multiplication units can be used for up and down projections (or up and down projection modules) in LoRA adaptation for FC layers. Normalization and activation functions are typically implemented using digital logic circuits. Data sampling and decision logic can be implemented using comparators and memory access units.

The I/O 140 comprises elements to interface any combination of the processor 110, the memory 120, and/or the DLA 130 to elements external to the computing device 100. Example external elements include mass storage devices, local and wide-area networks (such as the Internet), human interface components (such as keyboards, mice, and/or monitors), and other elements providing capabilities to extend and/or augment capabilities not otherwise provided by the computing device 100. In some implementations, the I/O 140 can receive a query for inference and output a result corresponding to the query after being processed by the LLMs executed by the computing device 100.

The Bus(es)/Interface(s) 150 enables communication between the elements coupled to it (e.g., the processor 110, the memory 120, the DLA 130 and/or the I/O 140). The Bus(es)/Interface(s) 150 variously comprises one or more serial and/or parallel communication channels as well as optional protocol conversion and/or adaptation capabilities to facilitate communication between the elements coupled to it.

Other partitionings of elements, coupling between elements, and capabilities and/or capacities of elements illustrated in the figure are contemplated, as well as additional elements, according to usage requirements.

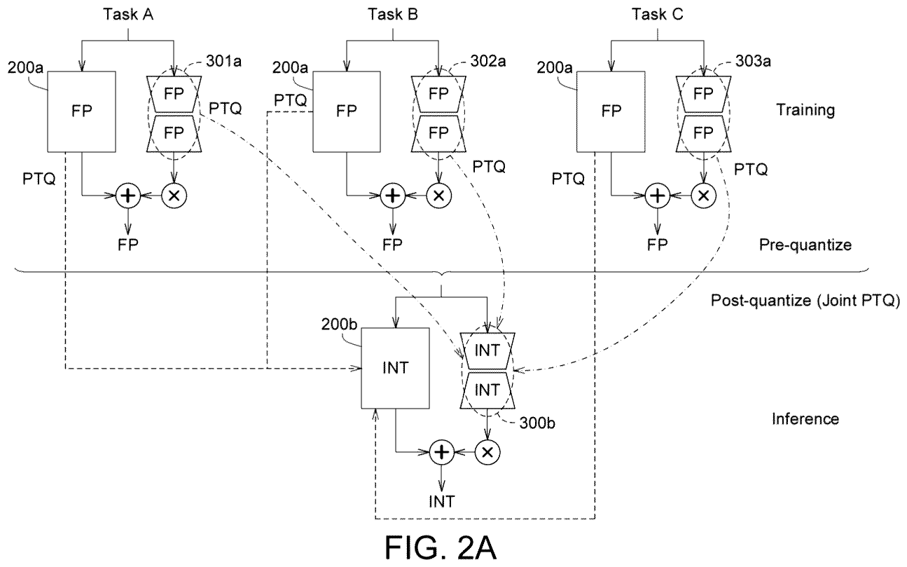

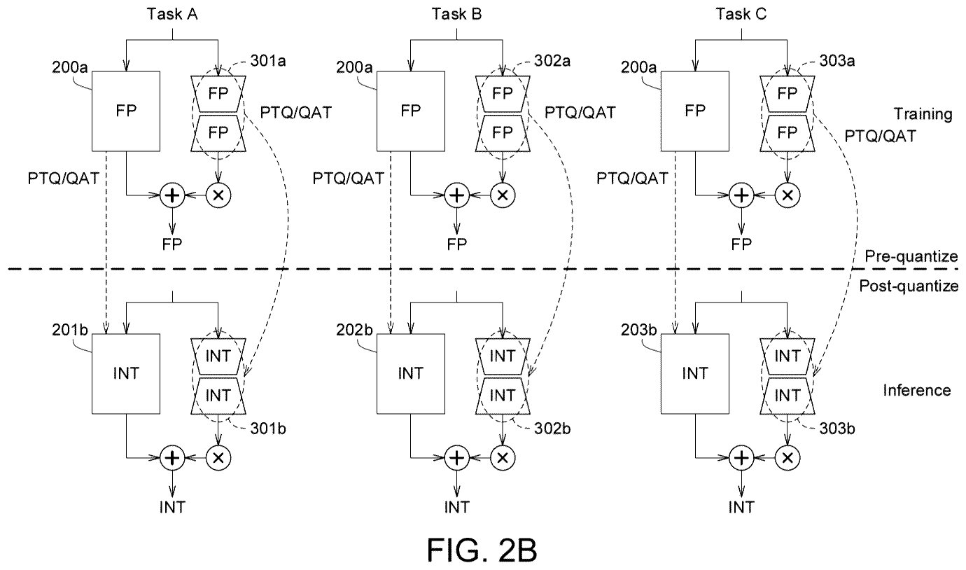

Accordingly, the LLM and the LoRA, with FC layer of LLM, provided by implementations of present disclosure can be implemented by the computing device as discussed above, and training means and the structure of the LoRA provided by implementations of present disclosure can be implemented by the computing device will be detailed described referring to FIGS. 2A to 4 as follows.

FIG. 2A is a diagram illustrating an example of joint PTQ (Post Training Quantization) for training multiple LoRAs (301a, 302a and 303a) and original weights of the FC layer 200a for different tasks (tasks A, B and C). Conceptually, joint PTQ is implemented as combining all tasks (tasks A, B and C) together and PTQ as one model. By the joint PTQ, LoRAs 301a, 302a and 303a for different tasks of the LLM can be quantized jointly. After the quantized by joint PTQ, the original weight in float point (FP) of FC layer 200a is quantized as the trained original weight in integer (INT) of FC layer 200b, and weights of multiple LoRAs, 301a, 320a and 303a, in FP are quantized jointly as trained weights in INT of single LoRA 300b, which can be used in multiple tasks (tasks A, B and C). Due to the joint PTQ, the trained original weight of FC layer 200b is the same for multiple tasks (tasks A, B and C), which means that the trained original weight of FC layer 200b can be shared in multiple tasks (tasks A, B and C) for saving memory usage and/or storage while executing the inference of LLM. However, since the joint PTQ, weights of multiple LoRAs, 301a, 320a and 303a, are quantized jointly into single set of quantization parameters (such as scales and zero-points) of LoRA 300b for multiple tasks (tasks A, B and C), which the accuracy of the inference of LLM for each task (for tasks A, B or C) will be decreased due to the single set of quantization parameters (such as scales and zero-points) of LoRA 300b. Additionally, when new task is added, re-PTQ is needed for each new added LoRA corresponding to the new added task and original LoRAs corresponding to the original tasks, and the accuracy of the inference of LLM for each task (including new added task and original tasks) will be further decreased.

FIG. 2B is a diagram illustrating an example of individual PTQ/QAT(Quantization Aware Training) for training multiple LoRAs (301a, 302a and 303a) and original weights of the FC layer 200a for different tasks. Conceptually, individual PTQ/QAT (Quantization Aware Training) is implemented as treating each task (tasks A, B or C) individually, and PTQ one model by each task, and multiple fakequants are inserted (such as frequent operators) while training LoRA for each task. By the training mean of individual PTQ/QAT for training LoRAs 301a, 302a and 303a for different tasks of the LLM, the FC layer 200a and multiple LoRAs 301a, 302a and 303a can be quantized or trained individually (such as by individual PTQ/QAT). After the quantized by individual PTQ/QAT, the original weight in float point (FP) of FC layer 200a is quantized or trained for different tasks as different trained original weights in integer (INT) of different FC layers 201b, 202b and 202c respectively used for tasks A, B and C, and weights of multiple LoRAs, 301a, 320a and 303a, in FP are quantized individually as different trained weights in INT of LoRAs, 301b, 302b and 303b, which can be respectively used in multiple tasks (tasks A, B and C). Due to the individual PTQ/QAT, original weight of FC layer and weights of multiple LoRAs, 301a, 320a and 303a, are quantized and trained individually regarding different tasks, which the accuracy of the inference of LLM for each task (for tasks A, B or C) will be increased due to the different sets of trained weights of FC layers and LoRAs for different tasks. However, since the individual PTQ/QAT, the quantized original weights of FC layers 201b, 202b and 203b are different for multiple tasks (tasks A, B and C), which means that the trained original weights of FC layers cannot be shared in different tasks (tasks A, B or C) such that the memory usage and/or storage will be significantly increased while implementing the LLM. Additionally, when new task is added, re-PTQ/re-QAT is needed for each new added LoRA and original weights of FC layer, and the accuracy of the inference of LLM for each task (including new added task and original tasks) will not be dropped since the weights of FC layer and LoRA are quantized or trained individually regarding the added task.

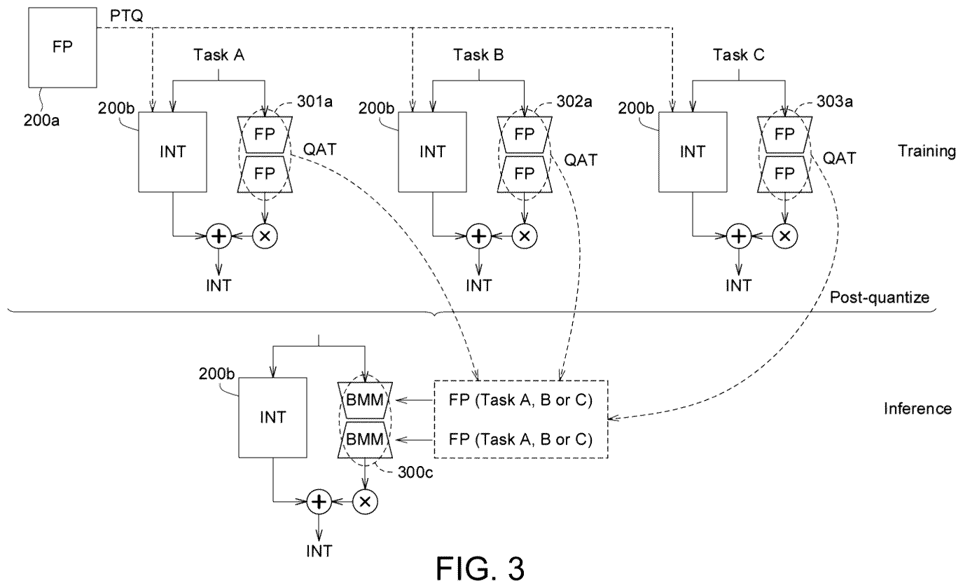

FIG. 3 is a diagram illustrating an example of Quantization-Aware LoRA Fine-Tune (QALFT) for training LoRAs, 301a, 302a and 303a, and original weights of the FC layer 200a for different tasks (tasks A, B and C), according to some implementations of the present disclosure. Conceptually, QALFT is using a mix of both PTQ and QAT discussed above, which enables to gain all the benefits of both PTQ/QAT, and remove all the disadvantages, of PTQ/QAT, as mentioned above. By the training mean of QALFT, the original weight in FP, such as FP 16, of FC layer 200a is firstly quantized and frozen (such as by PTQ) as the trained original weight in INT, such as INT16, of FC layer 200b. Secondly, for training LoRAs 301a, 302a and 303a for different tasks of the LLM, multiple LoRAs, 301a, 302a and 303a, in FP, such as FP16 or FP32, can be trained individually (such as by QAT) to obtain multiple sets of trained weights, stayed in FP, corresponding to different tasks (task A, B or C), which the multiple sets of trained weights in FP for different tasks can be stored in memory (such as the memory 120 of FIG. 1). During the inference, two BMMs can be implemented as down projection module and up projection module of LoRA 300c, and the multiple sets of trained weights in FP, stored in memory, for different tasks (tasks A, B and C) can be used as dynamic inputs of the two BMMs (included by LoRA 300c) depending on which task (tasks A, B or C) of LLM is being executed. For example, while the task A of LLM is executed, the trained weights in FP for task A can be used as dynamic input of the two BMMs (included by LoRA 300c). Due to the QALFT, the trained original weight of FC layer 200b is frozen for multiple tasks (tasks A, B and C), which means that the trained original weight of FC layer 200b can be shared in multiple tasks (tasks A, B and C) for saving memory usage and/or storage while executing the inference of LLM. Also, due to the QALFT, weights of multiple LoRAs, 301a, 320a and 303a, are trained individually regarding different tasks, which the accuracy of the inference of LLM for each task (for tasks A, B or C) will be increased due to the different sets of trained weights of LoRAs for different tasks which can be dynamically input into BMMs (included by LoRA 300c) according to which tasks (tasks A, B or C) is being executed.

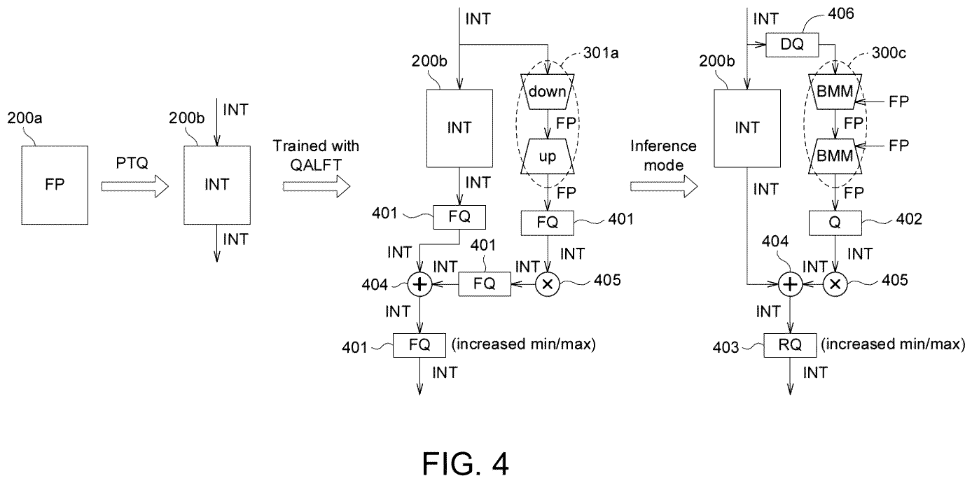

FIG. 4 is a diagram illustrating an example of the training structure of QALFT for LoRA 301a and original weights of the FC layer 200a for different tasks, and the inference structure of LoRA 300c and the FC layer 200b for different tasks according to some implementations of the present disclosure. From the left side of FIG. 4, firstly the original weight in FP of FC layer 200a is quantized and frozen (such as by PTQ) as the trained original weight in INT (with INT activations) of FC layer 200b. Secondly, for training (such as by QAT) the LoRA 301a (such as for task A of the LLM), the INT input is directly provided to the down projection module of LoRA 301a, where it is used to train the weights of the down projection module and to generate a FP output from the down projection module. Then, the down project FP output is input to the up projection module of the LoRA 301a for training weights of the up projection module of the LoRA 301a and for outputting an up projection FP output. While the training (QAT) for the Lora 301a with the FC layer 200b, multiple fakequant operators (FQs) 401 are respectively inserted to an output of the up projection module (of LoRA 301a), an output of the multiplier 405, an output of the FC layer 200b and an output of the adder 404, for performing the QAT, as shown by FIG. 4. The FQ 401 inserted to the output of the adder 404 can include an increased min/max of activation (input and output) range to prevent saturation after adding inputs of the adder 404.

During the inference, the structure of LoRA 300c with the FC layer 200b is formed as shown by the right side of FIG. 4. Specifically, a dequantizer (DQ) 406 is coupled to the FC layer 200b and a first BMM of LoRA 300c, and configured to dequantize an INT input to a FP output. The first BMM of LoRA 300c (corresponding to the down projection module of LoRA 301a) is configured to process the FP output from the DQ 406, and a first FP input from trained weights (such as corresponding to task A) of the down projection module of the LoRA 301a, to output a FP output. A second BMM of LoRA 300c (corresponding to the up projection module of LoRA 301a) is coupled to the first BMM and configured to process the first FP output from the first BMM and a second FP input from second weights (such as corresponding to task A) of the up projection module of the LoRA 301a, to output a second FP output. A quantizer (Q) 402 is coupled to the second BMM and configured to quantize the second FP output to an INT output. The multiplier 405 is coupled to the quantizer 402 and configured to multiply a pre-defined constant to output a multiplied INT output. The adder 404 is coupled to the FC layer 200b and the multiplier 405, and configured to add an INT FC output, from the FC layer 200b, and the multiplied INT output, to output an INT LoRA output. A requantizer (RQ) 403 is coupled to the adder 404 and configured to requantize the INT LoRA output to an INT inference output, which scales the increased min/max (increased by the FQ 401 coupled to the adder 404 during the training) to an original min/max of the activation range of the INT inference output.

Accordingly, instead of training LoRA using the original FP base LLM model, the base model (such as FC layer 200a) is firstly quantized by PTQ to the desired integer precision, and then the LoRAs (such as LoRAs 301a, 302a and 303a) can be attached and trained with LoRAs being aware of the already-quantized base model and learning to minimize quantization loss, leading to even better LoRA accuracy than regular QAT. Also, during the quantization process, algorithms for sharing weight, such as hessian-guided weight optimization (also can be referred as GPTQ), can be used to optimize the model weights by nudging the weights slightly, leading to better model accuracy after quantization.

Additionally, during training of the LoRAs, the PTQ-ed base model is first converted into a float model with fakequant operators attached to represent the quantization parameters of the base model, and for compatibility with common training frameworks. Since the base model is frozen in a post-quantized state, all LoRA tasks are trained to accommodate the same base model weights, hence only needing 1 set of quantized base model weights for all LoRA tasks. For quick swapping between trained weights of LoRAs for different tasks, the up projection module and down projection module of LoRA are replaced by batched matrix multiplications (BMMs) with dynamic inputs corresponding to different tasks, which enables plug-and-play for different LoRA tasks.

In some implementations, in order to avoid needing to re-PTQ for every new LoRA, the LoRAs can be set in FP16 precision, even for inference, which does not incur any penalty of any kind as FP16 uses the same amount of computation as INT16 as the original quantized integer precision.

In some implementations, for activation path (input and output paths) of LoRAs, the activation's dynamic range (such as minimum/maximum of the activation) of the FC layer can be arbitrarily copied to the activation path of LoRAs and be frozen as well, so that weights of LoRA can be trained to learn to adapt to the given activation range constraint during training.

It can be understood that FP mentioned herein can be implemented as FP16 or FP32. For example, FP32 can be used during training and on TensorFlow Lite (tflite) level (as FP16 is not supported on tflite). TensorFlow Lite, developed by Google Inc., is a software stack specifically for mobile development. Once the LoRA in FP compiled to DLA and executed by the computing device, it will run on FP16 due to FP32 may be not supported by hardware of computing device.

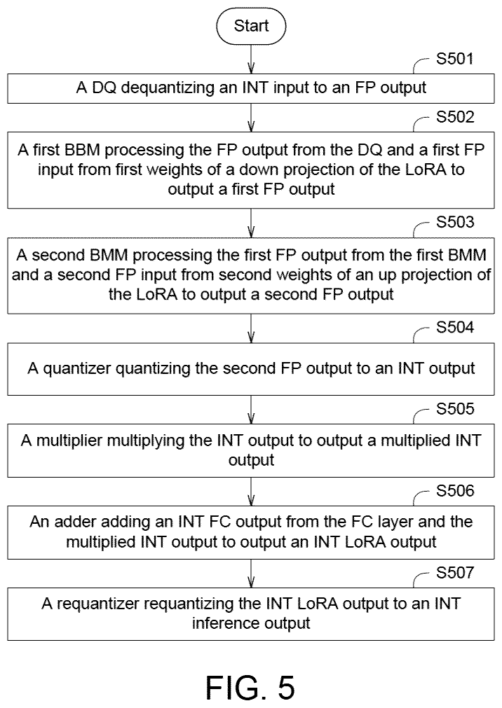

FIG. 5 is a flowchart of an example process for inference by LoRA with a FC layer of a LLM, according to some implementations of the present disclosure. In step S501, a DQ (such as DQ 406 of FIG. 4) dequantizes an INT input to an FP output.

In step S502, a first BMM (such as the upper BMM of LoRA 300c of FIG. 4) processes the FP output from the DQ and a first FP input from first weights of a down projection module of the LoRA (such as the down projection module of the LoRA 301a of FIG. 4) to output a first FP output.

In step S503, a second BMM (such as the lower BMM of LoRA 300c of FIG. 4) processes the first FP output from the first BMM and a second FP input from second weights of an up projection module of the LoRA (such as the up projection module of the LoRA 301a of FIG. 4) to output a second FP output.

In step S504, a quantizer (such as the quantizer 402 of FIG. 4) quantizes the second FP output to an INT output.

In step S505, a multiplier (such as the multiplier 405) multiplies the INT output to output a multiplied INT output.

In step S506, an adder (such as the adder 404 of FIG. 4) adds an INT FC output from the FC layer (such as the FC layer 200b of FIG. 4) and the multiplied INT output to output an INT LoRA output.

In step S507, a requantizer (such as the RQ 403 of FIG. 4) requantizes the INT LoRA output to an INT inference output.

In certain configurations, during a training for the Lora with the FC layer, the INT input is directly input to the down projection module for training the first weights and for outputting a down projection FP output, and the down project FP output is input to the up projection module for training the second weights and for outputting an up projection FP output. During the inference, the down projection module is replaced by the first BMM, and the up projection module is replaced by the second BMM.

In certain configurations, during the training for the Lora with the FC layer, multiple fakequant operators are respectively inserted to an output of the up projection module, an output of the multiplier, an output of the FC layer and an output of the adder, for performing a QAT. A fakequant operator, of the multiple of fakequant operator, inserted to the output of the adder, includes an increased min/max of activation range to prevent saturation after adding inputs of the adder.

In certain configurations, the fakequant operator inserted to the output of the adder and including the increased min/max of the activation range is replaced by the requantizer during the inference, for scaling the original min/max to an increased min/max of the activation range of the INT inference output.

In certain configurations, before the training for the Lora with the FC layer, base weights, with FP activations, of the FC layer is quantized by a PTQ to become base weights, with INT activations, and the base weights with INT activations is then frozen.

In certain configurations, during the inference, the first weights and second weights, after the training, respectively for the first FP input and the second FP input stay in forms of float points.

A computer program (also known as a program, software, software disclosure, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in a plurality of coordinated files (e.g., files that store one or more modules, sub programs, or portions of code). A computer program can be deployed for execution on one computer or on a plurality of computers that are located at one site or distributed across a plurality of sites and interconnected by a communications network.

The processes and logic flows described in this document can be performed by one or more programmable processors executing one or more computer programs to perform the functions described herein. The processes and logic flows can also be performed by, and apparatus can also be implemented as, special purpose logic circuitry, e.g., an FPGA (field programmable gate array) or an ASIC (application specific integrated circuit).

Processors, processing units, engines, and accelerators suitable for the execution of a computer program include, by way of example, both general and special purpose microprocessors, and any one or more processors of any kind of digital computer. Generally, a processor, a processing unit, an engine, or an accelerator will receive instructions and data from a read only memory or a random access memory or both. The essential elements of a computer can include a processor, a processing unit, an engine, or an accelerator for performing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data can include all forms of nonvolatile memory, media and memory devices, including by way of example semiconductor memory devices, e.g., EPROM, EEPROM, and flash memory devices; magnetic disks. The processor, the processing unit, the engine, or the accelerator and the memory can be supplemented by, or incorporated in, special purpose logic circuitry, such as other processors, processing units, engines, or accelerators.

While this document may describe many specifics, these should not be construed as limitations on the scope of an invention that is claimed or of what may be claimed, but rather as descriptions of features specific to particular implementations. Certain features that are described in this document in the context of separate implementations can also be implemented in combination in a single embodiment. Conversely, various features that are described in the context of a single embodiment can also be implemented in a plurality of implementations separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made according to what is disclosed.

What is claimed is:

1. A low rank adapter (LoRA) for inference with a fully connected (FC) layer of a large langue model (LLM), comprising:
a dequantizer (DQ), coupled to the FC layer and configured to dequantize an integer (INT) input to a floating point (FP) output;
a first batched matrix multiplication (BMM), coupled to the DQ and configured to process the FP output from the DQ and a first FP input from first weights of a down projection module of the LoRA, to output a first FP output;
a second BMM, coupled to the first BMM and configured to process the first FP output from the first BMM and a second FP input from second weights of an up projection module of the LoRA, to output a second FP output;
a quantizer, coupled to the second BMM and configured to quantize the second FP output to an INT output;
a multiplier coupled to the quantizer and configured to multiple the INT output, to output a multiplied INT output;
an adder, coupled to the FC layer and the multiplier, and configured to add an INT FC output, from the FC layer, and the multiplied INT output, to output an INT LoRA output; and
a requantizer, coupled to the adder and configured to requantize the INT LoRA output to an INT inference output.

2. The LoRA according to claim 1, wherein, during a training for the Lora with the FC layer, the INT input is directly input to the down projection module for training the first weights and for outputting a down projection FP output, and the down project FP output is input to the up projection module for training the second weights and for outputting an up projection FP output.

3. The LoRA according to claim 2, wherein, during the training for the Lora with the FC layer, a plurality of fakequant operators are respectively inserted to an output of the up projection module, an output of the multiplier, an output of the FC layer and an output of the adder, for performing a quantization aware training (QAT),
wherein a fakequant operator, of the plurality of fakequant operator, inserted to the output of the adder, includes an increased min/max of activation range to prevent saturation after adding inputs of the adder.

4. The LoRA according to claim 3, wherein the fakequant operator inserted to the output of the adder and including the increased min/max of the activation range is replaced by the requantizer during the inference, for scaling the original min/max to an increased min/max of the activation range of the INT inference output.

5. The LoRA according to claim 2, wherein, before the training for the Lora with the FC layer, base weights, with FP activations, of the FC layer is quantized by a post training quantization (PTQ) to become base weights, with INT activations, and the base weights with INT activations is then frozen.

6. The LoRA according to claim 2, wherein during the inference, the first weights and second weights, respectively for the first FP input and the second FP input stay in forms of float points after the training.

7. A computing device, comprising:
a processor, configured to execute an inference of a LLM;
a deep learning accelerator (DLA), coupled to the processor and compiled with a LoRA for the inference with a FC layer of the LLM; and
a memory, coupled to the processor and the DLA, and configured to store first weights of a down projection module of the LoRA and second weights of an up projection module of the LoRA,
wherein the LoRA comprises:
a DQ, coupled to the FC layer and configured to dequantize an INT input to an FP output;
a first BMM, coupled to the DQ and configured to process the FP output from the DQ and a first FP input from the first weights;
a second BMM, coupled to the first BMM and configured to process the first FP output from the first BMM and a second FP input from the second weights, to output a second FP output;
a quantizer, coupled to the second BMM and configured to quantize the second FP output to an INT output;
a multiplier coupled to the quantizer and configured to multiple the INT output, to output a multiplied INT output;
an adder, coupled to the FC layer and the multiplier, and configured to add an INT FC output, from the FC layer, and the multiplied INT output, to output an INT LoRA output; and
a requantizer, coupled to the adder and configured to requantize the INT LoRA output to an INT inference output.

8. The computing device according to claim 7, wherein, during a training for the Lora with the FC layer, the INT input is directly input to the down projection module for training the first weights and for outputting a down projection FP output, and the down project FP output is input to the up projection module for training the second weights and for outputting an up projection FP output.

9. The computing device according to claim 8, wherein, during the training for the Lora with the FC layer, a plurality of fakequant operators are respectively inserted to an output of the up projection module, an output of the multiplier, an output of the FC layer and an output of the adder, for performing a QAT,
wherein a fakequant operator, of the plurality of fakequant operator, inserted to the output of the adder, includes an increased min/max of activation range to prevent saturation after adding inputs of the adder.

10. The computing device according to claim 9, wherein the fakequant operator inserted to the output of the adder and including the increased min/max of the activation range is replaced by the requantizer during the inference, for scaling the original min/max to an increased min/max of the activation range of the INT inference output.

11. The computing device according to claim 8, wherein, before the training for the Lora with the FC layer, base weights, with FP activations, of the FC layer is quantized by a PTQ to become base weights, with INT activations, and the base weights with INT activations is then frozen.

12. The computing device according to claim 8, wherein during the inference, the first weights and second weights respectively for the first FP input and the second FP input stay in forms of float points after the training.

13. A method of using a LoRA for inference with a FC layer of a LLM, comprising:
dequantizing, by a DQ coupled to the FC layer, an INT input to an FP output;
processing, by a first BMM coupled to the DQ, the FP output from the DQ and a first FP input from first weights of a down projection module of the LoRA, to output a first FP output;
processing, by a second BMM coupled to the first BMM, the first FP output from the first BMM and a second FP input from second weights of an up projection module of the LoRA, to output a second FP output;
quantizing, by a quantizer coupled to the second BMM, the second FP output to an INT output;
multiplying, by a multiplier coupled to the quantizer, the INT output to output a multiplied INT output;
adding, by an adder coupled to the FC layer and the multiplier, an INT FC output, from the FC layer, and the multiplied INT output to output an INT LoRA output; and
requantizing, by a requantizer coupled to the adder, the INT LoRA output to an INT inference output.

14. The method according to claim 13, wherein, during a training for the Lora with the FC layer, the INT input is directly input to the down projection module for training the first weights and for outputting a down projection FP output, and the down project FP output is input to the up projection module for training the second weights and for outputting an up projection FP output.

15. The method according to claim 14, wherein, during the training for the Lora with the FC layer, a plurality of fakequant operators are respectively inserted to an output of the up projection module, an output of the multiplier, an output of the FC layer and an output of the adder, for performing a QAT,
wherein a fakequant operator, of the plurality of fakequant operator, inserted to the output of the adder, includes an increased min/max of activation range to prevent saturation after adding inputs of the adder.

16. The method according to claim 15, wherein the fakequant operator inserted to the output of the adder and including the increased min/max of the activation range is replaced by the requantizer during the inference, for scaling the original min/max to an increased min/max of the activation range of the INT inference output.

17. The method according to claim 14, wherein, before the training for the Lora with the FC layer, base weights, with FP activations, of the FC layer is quantized by a PTQ to become base weights, with INT activations, and the base weights with INT activations is then frozen.

18. The method according to claim 14, wherein during the inference, the first weights and second weights respectively for the first FP input and the second FP input stay in forms of float points after the training.
